(19) United States
(12) Patent Application Publication
(10) Pub. No.: US 2016/0317979 A1
(43) Pub. Date: Nov. 3, 2016

(54) GRAPHENE MEMBRANES AND METHODS FOR MAKING AND USING THE SAME

(71) Applicant: EMPIRE TECHNOLOGY DEVELOPMENT LLC, Wilmington, DE (US)

(72) Inventors: Kraig ANDERSON, San Mateo, CA (US); Angele SJONG, Louisville, CO (US)

(73) Assignee: EMPIRE TECHNOLOGY DEVELOPMENT LLC, Wilmington, DE (US)

(21) Appl. No.: 15/109,356

(22) PCT Filed: Jan. 21, 2014
(86) PCT No.: PCT/US2014/012345

§ 371 Date: Jun. 30, 2016

(51) Int. Cl. B01D 71/02; B01D 67/00; C01B 3/50; B01D 53/22

(52) U.S. Cl. CPC B01D 71/021; B01D 53/228; B01D 67/0053; C01B 3/503; B01D 2325/02; B01D 2325/06; C01B 2203/0405

(57) ABSTRACT

Techniques described herein are generally related to graphene membranes having gas-permeable substrates. Various example substrates may include a gas-permeable substrate with a convoluted surface and a graphene layer on the gas-permeable substrate. The membranes may also include nanopores formed on the graphene layer. The membranes may exhibit improved permeability properties. Methods and systems configured to make and use the membranes are also disclosed.

### BACKGROUND

Unless otherwise indicated herein, the materials described in this section are not prior art to the claims in this disclosure and are not admitted to be prior art by inclusion in this section.

Porous graphene is considered to be a desirable membrane for gas separation. Theoretical and experimental studies suggest that atom-scale holes in the graphene lattice may provide significant selectivity for separating gases based on molecular size. Further, graphene is a desirable candidate because the gas permeation rate through a membrane increases with decreasing thickness.

### SUMMARY

Some embodiments relate to a method of making a graphene membrane, the method comprising, for example: providing a gas-permeable substrate comprising a convoluted surface; applying graphene to the gas-permeable substrate; heating the graphene applied to the gas-permeable substrate at a temperature suitable for graphene to form an substantially flat surface over the gas-permeable substrate; and cooling the graphene applied to the gas-permeable substrate to a temperature suitable for graphene to form a wrinkled or buckled surface over the gas-permeable substrate.

Some embodiments relate to a graphene membrane comprising, for example: a gas-permeable substrate comprising a convoluted surface; and a graphene layer on the gas-permeable substrate, wherein the graphene layer includes one or more nanopores therein.

Some embodiments relate to a method of enriching a gas, the method comprising, for example: providing a graphene membrane comprising: a gas-permeable substrate comprising a convoluted surface; and a graphene layer on the gas-permeable substrate, wherein the graphene layer comprises one or more nanopores; and passing an input gas through the graphene membrane to form an enriched gas.

Some embodiments relate to a system for making a graphene membrane, the system comprising, for example: a controller; a graphene applicator configured via the controller to apply a graphene to a gas-permeable substrate; and a heater device configured via the controller to heat the graphene applied to the gas-permeable substrate at a temperature of at least about 700° C.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a flow diagram illustrating one example of a method of making a graphene membrane in accordance with at least some examples of the present disclosure.

FIG. 2 shows one example of a graphene membrane having gas-permeable substrates that is within the scope of the present disclosure.

FIG. 3 is a block diagram illustrating one example of a system that is configured to control one or more operations in accordance with at least some examples of the present disclosure.

FIGS. 4A-B are a block diagram illustrating one example of a computing device that may be configured to control one or more operations in accordance with at least some examples of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Briefly stated, the present disclosure generally describes techniques relating to graphene membranes containing a gas-permeable substrate with a convoluted surface and a graphene layer on the gas-permeable substrate. The membranes may have improved permeability properties. Methods and systems configured to make and use the membranes are also disclosed.

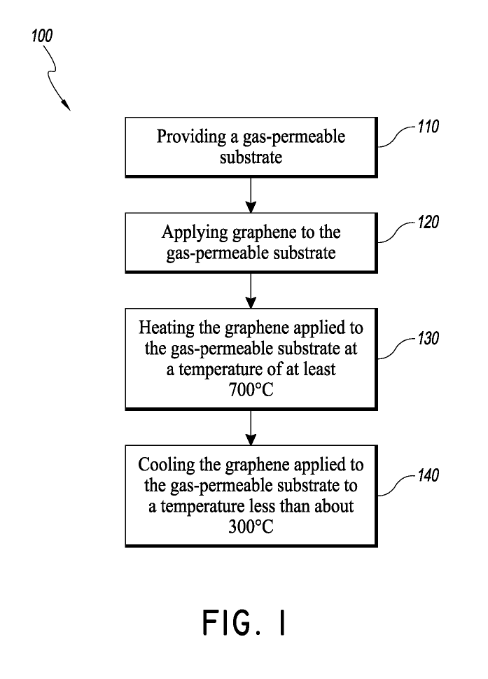

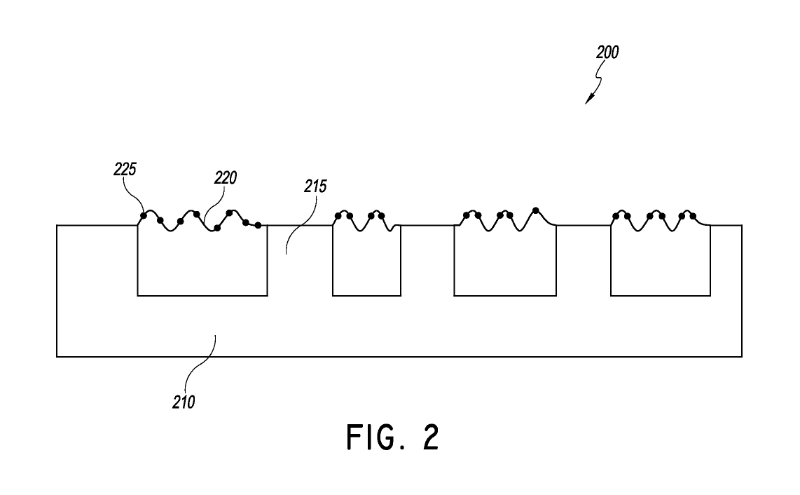

Some embodiments disclosed herein include a method of making a graphene membrane. FIG. 1 is a flow diagram illustrating one example of a method 100 of making a graphene membrane in accordance with at least some examples of the present disclosure. As illustrated in FIG. 1, method 100 may include one or more functions, operations, or actions as illustrated by one or more operations 110-140.

Processing for method 100 may begin at operation 110, “Providing a gas-permeable substrate having a convoluted surface.” Operation 110 may be followed by operation 120, “Applying graphene to the gas-permeable substrate surface.” Operation 120 may be followed by operation 130, “Heating the graphene applied to the gas-permeable substrate surface at a temperature of at least about 700° C.” Operation 130 may be followed by operation 140, “Cooling the graphene applied to the gas-permeable substrate surface to a temperature less than about 300° C.”

In FIG. 1, operations 110-140 are illustrated as being performed sequentially with operation 110 first and operation 140 last. It will be appreciated, however, that these operations may be reordered, combined, and/or divided into additional or different operations as appropriate to suit particular embodiments. In some embodiments, additional operations may be added. In some embodiments, one or more of the operations can be performed at about the same time.

At operation 110, “Providing a gas-permeable substrate comprising a convoluted surface” a suitable gas-permeable substrate is provided for supporting graphene applied to the substrate. The gas-permeable substrate can include a convoluted surface having one or more depressions or troughs disposed between protuberances or ridges to form the convoluted surface. As will be discussed further below, the convoluted surface can be configured so that graphene can be disposed on the protuberances or ridges of the convoluted surface and suspended over the depressions or troughs of the convoluted surface so that the surface of the graphene layer forms wrinkles or buckles with an increased surface area compared to a smooth, flat graphene layer suspended over the depressions or troughs of the convoluted substrate surface.

The arrangement of the depressions or troughs and protuberances or ridges of the convoluted surface is not particularly limited, and may, for example, be any arrangement where graphene can contact the protuberances or ridges of the convoluted surface and be suspended over the over the depressions or troughs. As one example, the depressions or troughs and protuberances or ridges can be parallel bands that extend the length of one side of the substrate. As another example, the depressions or troughs and protuberances or ridges can be a series of concentric circles or ellipses. The depressions or troughs and protuberances or ridges can include straight and/or curved surfaces. In some embodiments, the depressions or troughs and protuberances or ridges are arranged in a pattern. The pattern may, in some embodiments, cover substantially one side of the substrate. For example, the pattern may cover at least about 80% by area, at least about 90% by area, at least about 95% by area, at least about 99% by area, or about 100% by area, or a range between any two of the aforementioned values.

In some embodiments, the convoluted surface of depressions or troughs and protuberances or ridges may form a two-dimensional lattice. Non-limiting examples of lattices that may be formed by the convoluted surface include a rhombic lattice, a hexagonal lattice, a square lattice, a rectangular lattice, or a parallelogrammic lattice.

The depressions or troughs and protuberances or ridges of the convoluted surface may optionally intersect. For example, the depressions or troughs and protuberances or ridges may include a first set of parallel depressions or troughs and protuberances or ridges which intersect with a second set of parallel depressions or troughs and protuberances or ridges at an angle (e.g., intersect at 90°, 75°, 60°, 45°, or 15°) to form a grid. Depending on the angle of intersection and the spacing between the parallel protuberances or ridges, the depressions or troughs between the protuberances or ridges may form a parallelogram, a rectangle, or a square. As another example, the depressions or troughs and protuberances or ridges may be arranged to form a hexagonal structure.

The spacing between the depressions or troughs and protuberances or ridges of the convoluted structure can be such that graphene applied to the substrate can be in contact with the protuberances or ridges while being suspended over the depressions or troughs of the convoluted surface. The spacing may be varied depending on the size of graphene applied to the substrate. For example, the protuberances or ridges can be parallel bands that have a spacing of about 100 nm when applying graphene having dimensions of about 500 nm. The spacing between the protuberances or ridges can be, for example, at least about 50 nm, at least about 100 nm, at least about 200 nm, at least about 500 nm, at least about 1 μm, or at least about 5 μm. The spacing between the protuberances or ridges can be, for example, no more than about 1 mm, no more than about 500 μm, no more than about 100 μm, no more than 1 μm, no more than about 500 nm, or no more than about 200 nm. The spacing between the protuberances or ridges can be, for example, a value within a range of any of the aforementioned spacing values. In some embodiments, the spacing between the protuberances or ridges can be in the range of about 50 nm to about 1 mm. Applicants appreciate that the spacing may vary at different locations of the substrate for certain arrangements (e.g., a hexagonal lattice of convoluted surface), and in these circumstances, the average spacing can apply.

The width of each of the protuberances or ridges is not particularly limited, and may, for example, be less than the spacing between the protuberances or ridges. As will be discussed further below, the graphene layer can be in contact with the protuberances or ridges and suspended over the depressions or troughs, and the suspended portion of the graphene layer can be wrinkled to improve the properties of the porous graphene membrane. Applicants therefore appreciate that, when the width of the protuberances or ridges is small relative to the spacing between the protuberances or ridges, a greater proportion of graphene can be wrinkled to improve membrane properties. In some embodiments, the width of each of the protuberances or ridges can be no more than about 75% of the spacing between the protuberances or ridges. In some embodiments, the width of each of the protuberances or ridges can be no more than about 50% of the spacing between the protuberances or ridges. In some embodiments, the width of each of the protuberances or ridges can be no more than about 25% of the spacing between the protuberances or ridges. In some embodiments, the width of each of the protuberances or ridges can be a value within a range between two of the aforementioned values.

The width of each of the protuberances or ridges can be, for example, at least about 10 nm, at least about 50 nm, at least about 100 nm, at least about 500 nm, or at least about 1 μm. The width of each of the protuberances or ridges can be, for example, no more than about 500 μm, no more than about 100 μm, no more than about 1 μm, no more than about 500 nm, no more than about 200 nm, or no more than about 100 nm. In some embodiments, the width of each of the protuberances or ridges can be in the range of about 10 nm to about 500 μm. In some embodiments, the width of each of the protuberances or ridges can be a value within a range between any two of the aforementioned values.

The height of the protuberances or ridges is not very limited. In some embodiments, the protuberances or ridges may have a height in the range of about 20 nm to about 10 mm. In some embodiments, the protuberances or ridges may have a height in the range of about 100 nm to about 5 mm. In some embodiments, the protuberances or ridges may have a height in the range of about 100 nm to about 1 mm. In some embodiments, the height of each of the protuberances or ridges can be a value within a range between any two of the aforementioned values.

The gas-permeable substrate may be formed using various methods, such as nanoimprinting, photolithography, or etching, so as to form the convoluted surface. In some embodiments, the convoluted surface has a regular pattern of depressions or troughs disposed between protuberances or ridges. The substrate is not particularly limited to any material, so long as the substrate can be gas-permeable and withstand heating temperatures during processing. Examples of temperatures during processing include at least about 400° C., at least about 500° C., at least about 600° C., at least about 700° C., at least about 800° C., at least about 900° C., or at least about 1000° C. Examples of temperatures during processing include up to about 700° C., up to about 800° C., up to about 900° C., up to about 1000° C., up to about 1200° C., up to about 1500° C., up to about 2000° C. In some embodiments, the temperatures during processing can be a value within a range between any two of the aforementioned values. The time period for the elevated temperature can be at least about 5 minutes, at least about 10 minutes, at least about 15 minutes, at least about 20 minutes, at least about 25 minutes, or at least about 30 minutes. The time period for the elevated temperature can be up to about 10 minutes, up about 15 minutes, up to about 20 minutes, up to about 25 minutes, up to about 30 minutes, or up to about 45 minutes. The time period for the elevated temperature can be a time period within a range between any two of the aforementioned values.

The substrate can include, for example, a ceramic. In some embodiments, the substrate includes silicon or silica. The gas-permeable substrate may optionally include two or more materials, either as a mixture or separate components that are integrated to form the substrate. For example, the gas-permeable substrate may have silicon which forms the base and silica which forms the convoluted surface.

The gas-permeable substrate may be porous to improve gas-permeability. The gas-permeable substrate may, for example, have a pore volume of at least about 5%, at least about 10%, at least about 20%, or at least about 30%. In some embodiments, the pore volume of the gas-permeable substrate can be a value within a range between any two of the aforementioned values. For example, in some embodiments, the gas-permeable substrate can have a pore volume of about 10% to about 30%. The gas-permeable substrate may, for example, have an average pore size of at least about 20 nm, at least about 50 nm, or at least about 100 nm. The gas-permeable substrate can have an average pore size within a range between any two of the aforementioned values. In some embodiments, the gas-permeable substrate may be permeable to hydrogen, helium, or other small gas molecules. In some embodiments, the gas-permeable substrate may be permeable to hydrogen and methane. In some embodiments, the gas-permeable substrate may be permeable to helium and methane.

Returning to FIG. 1, at operation 120 “Applying graphene to the convoluted surface on the gas-permeable substrate”, graphene is applied on the substrate to form a membrane. The graphene can be applied to the substrate, in some embodiments, by dispersing the graphene in a solution and applying the solution to the substrate surface. For example, graphene may be dispersed in toluene and then the mixture applied to the substrate surface. The toluene can be removed by evaporation, such as by applying heat and/or a vacuum. The dispersion of graphene can be applied to the substrate using various techniques, such as dip coating, spin coating, roll coating, spray coating, air knife coating, slot die coating, or rod bar coating. The application of graphene may optionally be repeated one or more times until a sufficient amount of graphene is placed on the substrate surface.

The source of graphene is not particularly limited, and may be obtained by various techniques. For example, graphene can be obtained using exfoliation techniques. The graphene may, in some embodiments, be reduced graphene oxide. For example, graphene oxide may be obtained by a Hummers or modified Hummers process and then subsequently reduced. In some embodiments, reduced graphene oxide may be applied to the substrate and subsequently reduced (e.g., by heating under a reducing atmosphere).

The total thickness of the layer of graphene applied to the substrate may be sufficient to provide suitable membrane properties. For example, the graphene applied may be sufficiently thick so that the membrane is selectively permeable to smaller gas molecules (e.g., H₂ and/or He), while sufficiently thin to provide a suitable rate of transport through the membrane for small gas molecules. The graphene layer can have a thickness of, for example, less than about 10 nm, less than about 5 nm, or less than about 1 nm, or 0.3 nm thick. The graphene layer can have a thickness within a range between any two of the aforementioned values. In some embodiments, the graphene is applied to form a monolayer of graphene, such that the thickness is about one-atom thick (e.g., about 0.3 nm thick). The permeance of the membrane to a targeted gas molecule can be selected by modifying one or more parameters, such as pore size, kinetic diameter of the targeted gas, temperature, pressure differential across the membrane, and pore density. In some embodiments, the relative permeance of the target molecule through the buckled porous graphene is increased relative to that of flat porous configuration of an otherwise identical graphene layer. For example, the relative permeance of the buckled porous graphene B may be related to the flat porous graphene F by the ratio A_{B}/A_{F}, the ratio of the full nano-corrugated surface area of the buckled graphene A_{B} divided by the surface area of the flat graphene A_{F} of the same nominal surface area (i.e., A_{F}). That is, the the buckled porous graphene B may have a greater relative permeance compared to the flat porous graphene F by packing a greater surface area of graphene, and thus a greater number of pores, into the same nominal filter cross section as the area of the flat porous graphene F. Thus, the buckled porous graphene B may have a greater relative permeance compared to the flat porous graphene F as multiplied by A_{B}/A_{F}. In some embodiments, the ratio A_{B}/A_{F} may range from about 1.1:1 to 10⁶:1, for example, at least about 1.1:1, 2:1, 5:1, 10:1, 25:1, 50:1, 75:1, 10²:1, 10³:1, 10⁴:1, 10⁵:1, or 10⁶:1, or any subrange between the preceding values. In another example, the relative permeance of the buckled porous graphene B may be related to the flat porous graphene F by a scaling factor Sc relating to increased collisions of gas molecules in the corrugations or buckles of the buckled porous graphene B compared to collisions with the flat porous graphene F. That is, the buckled porous graphene B may have a greater relative permeance compared to the flat porous graphene F as multiplied by Sc. In various embodiments, the scaling factor Sc may have a value ranging from about 1.1 to about 10⁶, for example, at least about 1.1, 1.5, 2, 3, 4, 5, 10, 25, 50, 75, 10², 10³, 10⁴, 10⁵, or 10⁶, or any subrange between the preceding values. The scaling factor Sc may operate dependently or independently of the ratio A_{B}/A_{F}.

The graphene applied to the gas-permeable substrate can include nanopores. Without being bound to any particular theory, nanopores may permit selective passage of atomic or molecular species (e.g., H₂ and/or He) through the graphene. The average diameter of the nanopores can be, for example, less than or equal to about 10 nm, less than or equal to about 6 nm, less than or equal to about 4 nm, or less than or equal to about 2 nm. The average diameter of the nanopores can be, for example, at least about 0.1 nm, at least about 0.5 nm, at least about 1 nm, or at least about 2 nm. The average diameter of the nanopores can be a diameter within a range between any two of the aforementioned values. For example, in some embodiments, the average diameter of the nanopores can be in the range of about 0.1 nm to about 10 nm, or in the range of about 0.5 nm to about 4 nm. The nanopores may, for example, be each independently formed by a vacancy of one, two, three, four, five, or six carbons atom in the graphene, or a range therebetween. In some embodiments, at least about 80% of the nanopores have six, five, four, three or less carbon atom vacancies (e.g., 90% of the nanopores are each formed by a vacancy of three carbon atoms).

The nanopores may be formed, in some embodiments, by ion etching the graphene. In some embodiments, the nanopores may be formed by reacting the graphene applied to the convoluted surface with a compound represented by R-Het*, wherein Het* is nitrene or activated oxy, such as oxy radical, oxy anion, hydroxyl, carboxyl, or carboxylate; R is —R^{a}, —SO₂R^{a}, —(CO)OR^{a}, or —SiRaR^{b}R^{c}; and R^{a}, R^{b}, and R^{c} are each independently aryl or heteroaryl. Methods of forming nanopores in graphene are further disclosed in International Application Nos. PCT/US2012/22798 and PCT/US2012/22858, filed on Jan. 26, 2012 and Jan. 27, 2012, respectively. Both applications are commonly owned by the Assignee, filed in English, and designate the United States. These applications are hereby incorporated by reference in their entirety.

The nanopores may optionally be formed in the graphene after applying the graphene to the substrate. For example, the graphene can be applied to the substrate and then ion etching can be used to form the nanopores. Accordingly, Applicants appreciate that the step of forming nanopores can occur at various points in the process. The nanopores may be formed in the graphene, for example, before applying the graphene to the substrate (e.g., before operation 120 as depicted in FIG. 1), after applying the graphene to the substrate (e.g., after operation 120 as depicted in FIG. 1), after heating the substrate (e.g., after operation 130 as depicted in FIG. 1), or after cooling the substrate (e.g., after operation 140 as depicted in FIG. 1). Furthermore, multiple steps of forming nanopores may be completed at different periods during the process. For example, nanopores can be formed before applying the graphene to the substrate, and additional nanopores can be formed after cooling the graphene.

In some embodiments, the graphene is applied to the substrate such that at least a portion of the graphene contacts two or more of the protuberances or ridges on the gas-permeable substrate. In some embodiments, the graphene is applied to the convoluted substrate surface such that at least a first portion of the graphene is in contact with the protuberances or ridges while at least a second portion of the graphene is not in contact with any portion of the substrate surface. For example, the protuberances or ridges can be parallel bands and the graphene may contact two of the bands and be suspended over the depression or trough disposed between the bands.

At operation 130, “Heating the graphene applied to the gas-permeable substrate surface at a temperature of at least about 700° C”, the graphene layer may be heated to obtain a substantially flat graphene layer. Without being bound to any particular theory, it is believed that graphene will contract due to a negative thermal expansion coefficient, which can reduce or remove bending or curves in the graphene layer. In some embodiments, the graphene layer applied to the gas-permeable substrate may be heated under a vacuum or inert atmosphere. As a specific non-limiting example, the gas-permeable substrate and graphene layer may be heated in a vacuum furnace to 750° C. using a pre-determined heating procedure (e.g., elevate temperature at 5° C./min. and then maintain at 750° C. for 20 min.).

At operation 140, “Cooling the graphene applied to the gas-permeable substrate to a temperature less than about 300° C”, the graphene layer applied to the gas-permeable substrate may be cooled to obtain a graphene layer with a wrinkled or buckled surface. Without being bound to any particular theory, it is believed that the graphene expands upon cooling due to a negative thermal expansion coefficient. Portions of the graphene can adhere to the protuberances or ridges due to van der Waals forces, which causes portions of the graphene extending between adjacent protuberances or ridges to buckle when expanding, which result in a wrinkled confirmation. This phenomenon is further described in Bao et al., “Controlled ripple texturing of suspended graphene and ultrathin graphite membranes,” Nature Biotechnology, (2009), Vol. 4, pp. 562-66. By forming a winkled or buckled structure in the graphene, the surface area may be increased to improve transport of small molecules through the graphene. In some embodiments, the graphene applied to the gas-permeable substrate may be cooled under a vacuum and/or in an inert atmosphere, such as a nitrogen gas or a noble gas such as helium, neon, argon, krypton or xenon. As a specific non-limiting example, the gas-permeable substrate and graphene may be cooled, after heating at 750° C., to about 50° C. at a rate of 10° C./ min and then placed in ambient conditions to cool to room temperature. As discussed above, nanopores may optionally be formed in the graphene after cooling.

The resulting graphene membrane may be configured to selectively separate smaller compounds from a fluid mixture (e.g., a gas). By forming a wrinkled or buckled surface in the graphene between the protuberances or ridges, the surface area can be increased which can improve the rate of transport for the compounds.

While the expanded graphene is described as having a wrinkled or buckled surface, it is contemplated herein that the surface of the graphene can be characterized by other shapes as well. The expanded graphene (e.g., the cooled graphene) possesses a surface area greater than the contracted graphene (e.g., the heated graphene). In some embodiments, the expanded graphene possesses at least a 10%, at least a 20%, at least a 30%, at least a 40%, at least a 50%, at least a 60%, at least a 70%, at least a 80%, at least a 90%, or at least a 100% greater surface area than the contracted graphene. In some embodiments, the expanded graphene possesses up 20%, up to a 30%, up to 40%, up to 50%, up to 60%, up to 70%, up to 80%, up to 90%, up to 100%, up to 110%, up to 120%, up to 130%, up to 140%, or up to 150% greater surface area than the contracted graphene. The greater of the expanded graphene relative to the contracted graphene can be an amount within a range between any two of the aforementioned values.

Some embodiments disclosed herein include a graphene membrane having a gas-permeable substrate comprising protuberances or ridges distributed on the gas-permeable substrate and a graphene layer in contact with protuberances or ridges of the gas-permeable substrate. The membrane may be formed, in some embodiments, using the methods disclosed herein. For example, the composite may be formed by the method depicted in FIG. 1. The membrane, for example, may have improved permeability.

FIG. 2 shows one example of membrane 200 having a gas-permeable substrate with a convoluted surface comprising protuberances or ridges distributed on the gas-permeable substrate and graphene layers on the gas-permeable substrate in accordance with at least some examples of the composition in the present disclosure. Gas-permeable substrate 210 comprises protuberances or ridges 215. The characteristics of gas-permeable substrate 210 and protuberances or ridges 215 can be the same as described above with regard to operation 110 in method 100 as depicted in FIG. 1. For example, the gas-permeable substrate can be composed of porous silica, while the protuberances or ridges can be parallel bands having depressions or troughs disposed between the parallel bands. As discussed above, the protuberances or ridges on the convoluted surface of the gas-permeable substrate may, for example, be patterned and/or form a two-dimensional lattice. Protuberances or ridges 215 may be formed by, for example, nanoimprinting, photolithography, etching, or other similar processes as discussed above with regard to operation 110 as depicted in FIG. 1.

The gas-permeable substrate may include, in some embodiments, one or more of silicon or silica. In some embodiments, the gas-permeable substrate has a pore volume in the range of about 10% to about 30%. In some embodiments, the gas-permeable substrate has a pore size of about 20 nm or more. In some embodiments, the gas-permeable substrate is permeable to hydrogen or helium.

Graphene layer 220 is in contact with the protuberances or ridges 215 and may include one or more nanopores 225, which can be distributed on the surface of the graphene and configured to be selectively permeable to smaller molecules. The average diameter of the nanopores can be, for example, less than or equal to about 10 nm, less than or equal to about 6 nm, less than or equal to about 4 nm, or less than or equal to about 2 nm. The average diameter of the nanopores can be, for example, at least about 0.1 nm, at least about 0.5 nm, at least about 1 nm, or at least about 2 nm. In some embodiments, the average diameter of the nanopores can be in the range of about 0.1 nm to about 10 nm, or in the range of about 0.5 nm to about 4 nm. The nanopores may, for example, be each independently formed by a vacancy of one, two, three, four, five, or six carbons atom in the graphene. In some embodiments, at least about 80% of the nanopores have six, five, four, three or less carbon atom vacancies (e.g., 90% of the nanopores are each formed by a vacancy of three carbon atoms).

As shown in FIG. 2, Graphene layer 220 can optionally include wrinkles or ripples in the regions extending between the protuberances or ridges. As discussed above, graphene layer 220 may have a wrinkled surface that may be formed by, for example, heating the graphene layer on the gas-permeable substrate at a temperature of at least about 700° C. and cooling the graphene on the gas-permeable substrate to a temperature less than about 300° C. (e.g., at operation 130 and 140 as depicted in FIG. 1). The wrinkled surface on the graphene layer 220, in some embodiments, may be configured to improve permeability of the graphene membrane as compared to a graphene membrane having a substantially flat graphene layer.

In some embodiments, graphene membrane 200 is selectively permeable to H₂ relative to CH₃. For example, the selectivity can be at least about 200:1 or at least about 1000:1.

Some embodiments disclosed herein include a method of enriching a gas including providing a graphene membrane having a gas-permeable substrate. The gas-permeable substrate can include protuberances or ridges distributed on the gas-permeable substrate. The graphene membrane may further include a graphene layer on the gas-permeable substrate, and may be in contact with the protuberances or ridges of the gas-permeable substrate. The method may further include passing an input gas through the graphene membrane to form an enriched gas. The graphene membrane can generally be any of the graphene membranes disclosed in the present disclosure. For example, the graphene membrane may be the product of method 100 as depicted in FIG. 1 or graphene membrane 200 as depicted in FIG. 2.

The input gas may, in some embodiments, include hydrogen or helium. In some embodiments, the input gas includes hydrogen and methane. The concentration of the hydrogen in the enriched gas may be greater than the concentration of hydrogen in the input gas in some embodiments. In some embodiments, the concentration of helium in the enriched gas is greater than the concentration of helium in the input gas. For example, the molar concentration for hydrogen and/or helium may be enriched by at least about 100%, at least about 200%, at least about 500%, or at least about 1000%.

Non-limiting examples of other suitable compounds that may be enriched from the input gas include helium, neon, argon, xenon, krypton, radon, hydrogen, nitrogen, oxygen, carbon monoxide, carbon dioxide, sulfur dioxide, hydrogen sulfite, nitrogen oxide, a C₁₋₄ alkane (e.g., methane, ethane, propane, or butane), a silane, water, an organic solvent, or a haloacid. The concentration of these compounds in the enriched gas may be greater than the concentration in the input gas. For example, the molar concentration may be enriched for any one of these compounds by at least about 100%, at least about 200%, at least about 500%, or at least about 1000%.

In some embodiments, the input gas may be passed through the graphene membrane at a pressure of at least about 1 atm. In some embodiments, the input gas may be passed through the graphene membrane at a pressure of at least about 1.2 atm. In some embodiments, the input gas may be passed through the graphene membrane at a pressure of at least about 1.5 atm. In some embodiments, the input gas may be passed through the graphene membrane at a pressure of at least about 2 atm. In some embodiments, the input gas may be passed through the graphene membrane at a pressure of at least about 5 atm.

The graphene membrane may be subjected to heating to improve or rejuvenate the wrinkled structure in the graphene. For example, after using the graphene membrane to enrich a fluid for an extended period of time, the wrinkled structure may be diminished. Thus, the method of enriching the gas may include heating and cooling the graphene membrane to provide or increase the wrinkled structure. For example, after enriching a gas using the graphene membrane, the graphene membrane may be subjected to heating and cooling as described in operation 130 and operation 140 as depicted in FIG. 1. In some embodiments, the method of enriching a gas may include heating the graphene membrane at a temperature of at least about 700° C. after passing the input gas through the graphene membrane; cooling the graphene membrane to a temperature less than about 300° C.; and passing a second input gas through the graphene membrane to form a second enriched gas. The second input gas may, in some embodiments, have about the same composition as the input gas in other embodiments.

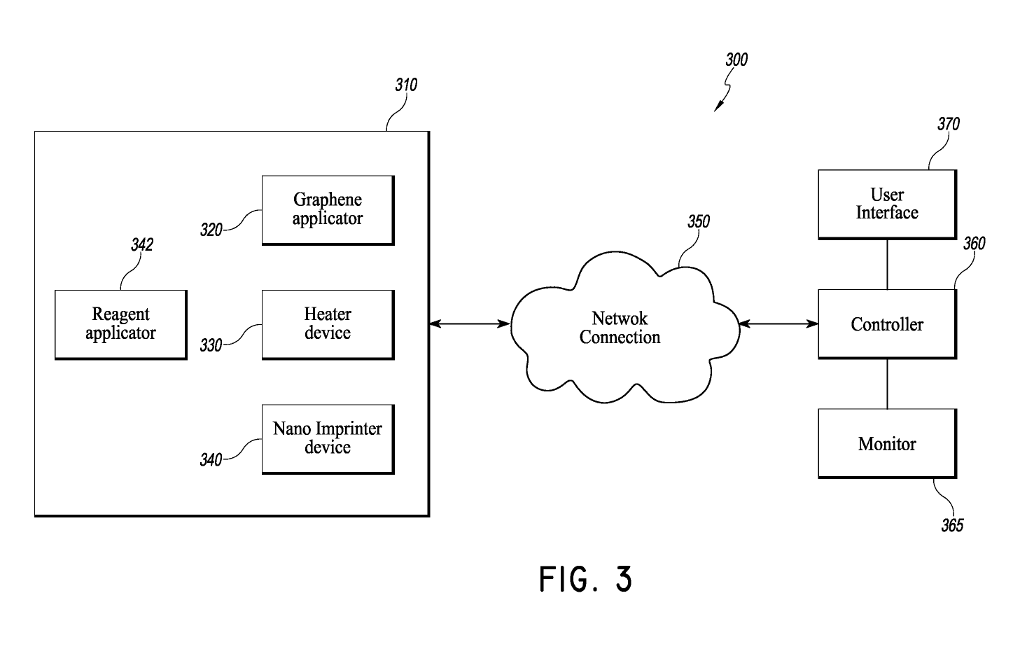

Some embodiments disclosed herein include a system for making a graphene membrane having a gas-permeable substrate comprising protuberances or ridges and a graphene layer on the surface of the gas-permeable substrate. FIG. 3 is a block diagram illustrating one example of a system that is configured to control one or more operations in accordance with at least some examples of the present disclosure. For example, equipment for performing operations for the flow diagram of FIG. 1 may be included in system 300.

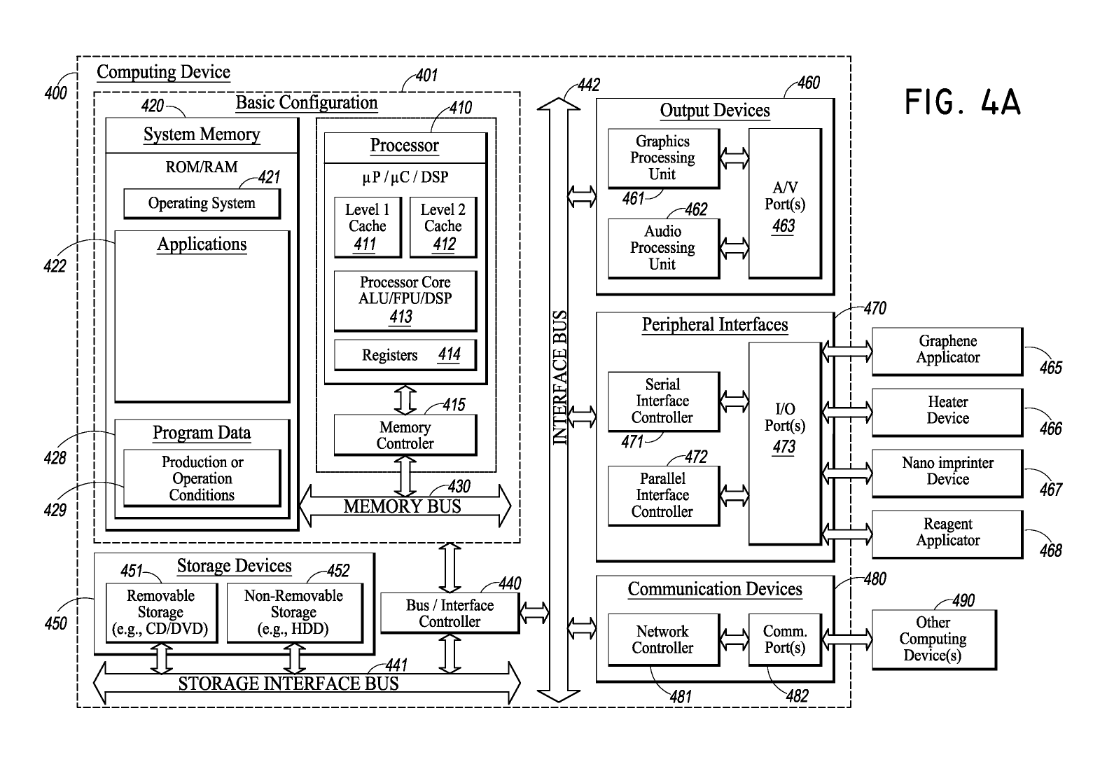

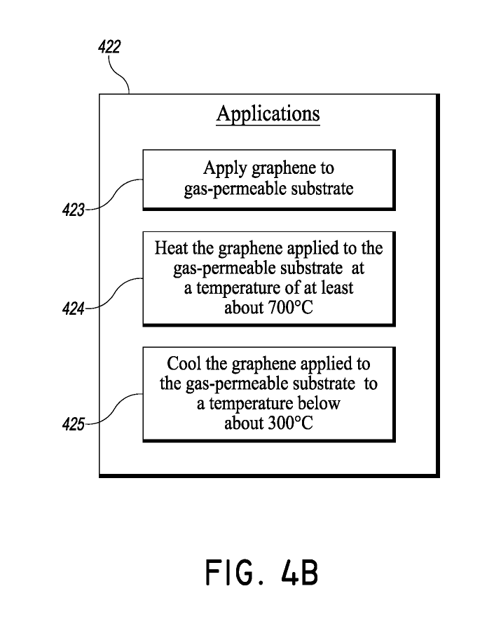

System 300 may include a processing plant or facility 310 that is arranged in communication with a controller or processor 360. Processor or controller 360 may be the same or different controller as processor 410 described later with respect to FIGS. 4A-B. In some embodiments, processing plant or facility 310 may be adapted to communicate with controller or processor 360 via a network connection 350. Network connection 350 may be a wireless connection or a wired connection or some combination thereof

In some embodiments, controller or processor 360 may be adapted to communicate operating instructions for various systems or devices in processing plant 310, which may include, for example, control of one or more operating conditions. Controller or processor 360 may be configured to monitor or receive information from processing plant 310 and utilize the information as feedback to adjust one or more operating instructions communicated to processing plant 310.

In some embodiments, the operating conditions may be presented on a monitor or display 365 and a user may interact with a user interface 370 to adapt or adjust various aspects of the processing. Non-limiting examples of aspects of the process that may be presented on monitor or display 365 may include time, temperature, pressure, heating rate for the graphene, atmosphere for processing the graphene (e.g., vacuum or inert gas), cooling rate for the graphene, configuration of the convoluted surface of the gas-permeable substrate, thickness of the graphene layer, and the like. Monitor 365 may be in the form of a cathode ray tube, a flat panel screen such as an LED display or LCD display, or any other display device. The user interface 370 may include a keyboard, mouse, joystick, joypad, write pen, touch pad, or other device such as a microphone, video camera, or other user input device. In some examples the monitor and the user interface may be combined in a single device, for example using a touch-screen device, a personal computing device, a tablet computing device, a smartphone device, or a personal data assistant type of device, or any other device that includes a user interface and a monitor.

In some embodiments, processing facility 310 may include one or more of a graphene applicator 320, a heater device 330, a nanoimprinter device 340, and/or a reagent applicator 342. In some embodiments, graphene applicator 320 may be configured via controller 360 to apply graphene to the gas-permeable substrate (e.g., as in operation 120 depicted in FIG. 1). Graphene applicator 320 may include, for example, a spin coater or a spray coater. Controller 360 may be configured to adjust conditions for the graphene application (e.g., rotation or spray rate) effective to apply graphene on the gas-permeable substrate. In some embodiments, graphene applicator 320 may be fluidly coupled to one or more reservoirs containing graphene. The graphene may be dispersed within a solvent (e.g., toluene) in the reservoir (not shown). Controller 360 may be configured to adjust valves (not shown) to selectively control an amount and/or rate of materials delivered from the one or more reservoirs into graphene applicator 320.

Heater device 330 may be configured via controller 360 to heat the graphene applied to the gas-permeable substrate at a temperature of about 700° C. (e.g., as in operation 130 depicted in FIG. 1). Heater device 330 may include, for example, an oven or a furnace. Controller 360 may be configured to adjust the temperature in the heater device (e.g., temperature set point or set points, temperature range, rate of change of temperature, etc.) to maintain conditions effective to heat the graphene applied to the gas-permeable substrate.

Nanoimprinter device 340 may be configured via controller 360 to form convoluted surface of the gas-permeable substrate (e.g., as in operation 110 depicted in FIG. 1). In some embodiments, nanoimprinter device 340 may be, for example, a photolithographer device and the like.

Reagent applicator 342 may be configured via controller 360 to apply a reagent to the graphene layer, wherein the applied reagent is effective to promote formation of nanopores in the graphene layer (e.g., as in operation 120 depicted in FIG. 1). Reagent applicator 342 may be, for example, one or more of a solvent caster, a dip coater, a doctor blade, a spin coater, a spray coater, or an inkjet printer. The reagent applicator can be fluidly coupled to one or more reservoirs containing a reagent to the graphene layer. Controller 360 may be configured to selectively adjust valves (not shown) to control an amount or flow rate of the applied reagent.

FIGS. 4A-B is a block diagram illustrating one example of a computing device that may be configured to control one or more operations in accordance with at least some examples of the present disclosure. For example, operations for the flow diagram of FIG. 1 may be performed by computing device 400. In a very basic configuration, computing device 400 typically includes one or more controllers or processors 410 (hereinafter simply “processor 410”) and system memory 420. A memory bus 430 may be used for communicating between the processor 410 and the system memory 420.

Depending on the desired configuration, processor 410 may be of any type including but not limited to a microprocessor (μP), a microcontroller (μC), a digital signal processor (DSP), or any combination thereof. Processor 410 may include one or more levels of caching, such as a level one cache 411 and a level two cache 412, a processor core 413, and registers 214. The processor core 413 may include an arithmetic logic unit (ALU), a floating point unit (FPU), a digital signal processing core (DSP Core), or any combination thereof. A memory controller 415 may also be used with the processor 410, or in some implementations the memory controller 415 may be an internal part of the processor 410.

Depending on the desired configuration, the system memory 420 may be of any type including but not limited to volatile memory (such as RAM), non-volatile memory (such as ROM, flash memory, etc.), or any combination thereof. System memory 420 typically includes an operating system 421, one or more applications 422, and program data 426. As shown in FIG. 4B, applications 422 may include, for example, “Apply graphene to gas-permeable substrate” at application 423; “Heat the graphene applied to the gas-permeable substrate at a temperature of at least about 700° C.” at application 424; and “Cool the graphene applied to the gas-permeable substrate to a temperature below about 300° C.” at operation 425. These applications may correspond to operation 120, operation 130, and operation 140, respectively, as depicted in FIG. 1. Returning to FIG. 4A, program data 428 may include, for example, production data and/or operating conditions data 429 that may be used by one or more of applications 423-427.

Computing device 400 may have additional features or functionality, and additional interfaces to facilitate communications between the basic configuration 401 and any required devices and interfaces. For example, a bus/interface controller 440 may be used to facilitate communications between the basic configuration 401 and one or more data storage devices 450 via a storage interface bus 441. The data storage devices 450 may be removable storage devices 451, non-removable storage devices 452, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable and non-removable media implemented in any method or technology for storage of information, such as computer readable instructions, data structures, program modules, or other data.

System memory 420, removable storage 451, and non-removable storage 452 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and that may be accessed by computing device 400. Any such computer storage media may be part of device 400.

Computing device 400 may also include an interface bus 442 for facilitating communication from various interface devices (e.g., output interfaces, peripheral interfaces, and communication interfaces) to the basic configuration 401 via the bus/interface controller 440. Example output devices 460 include a graphics processing unit 461 and an audio processing unit 462, which may be configured to communicate to various external devices such as a display or speakers via one or more A/V ports 463. Example peripheral interfaces 470 include a serial interface controller 471 or a parallel interface controller 472, which may be configured to communicate with external devices such as input devices (e.g., keyboard, mouse, pen, voice input device, touch input device, etc.) or other peripheral devices (e.g., printer, scanner, etc.) via one or more I/O ports 473. For example, in some embodiments, first reaction chamber 465, second reaction chamber 466, solvent applicator 467, heating device 468, and third reaction chamber 469 may be optionally connected via an I/O port and used to deposit nanostructures onto a substrate. An example communications device 480 includes a network controller 481, which may be arranged to facilitate communications with one or more other computing devices 490 over a network communication via one or more communication ports 482.

The communications connection is one example of a communication media. Communication media may typically be embodied by computer readable instructions, data structures, program modules, or other data in a modulated data signal, such as a carrier wave or other transport mechanism, and include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media.

With respect to the use of substantially any plural and/or singular terms herein, those having skill in the art can translate from the plural to the singular and/or from the singular to volume of wastewater can be received in the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

### EXAMPLES

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

### Example 1

A microporous silica substrate is obtained having a flat surface. A photolithographic-etch process is employed to etch a series of channels and ridges into the flat surface of the microporous silica substrate. The channels are etched to have a width of about 100 micrometers and a depth of about 100 micrometers. The channels are etched such that the remaining ridges between the channels have a width of about 1 micrometer to about 10 micrometers.

Separately, monolayer graphene membrane is obtained and placed on a substrate in a vacuum chamber. Nanoscale pores are formed in the monolayer graphene by chemical, energetic, or mechanical etching, for example, etching under vacuum with an electron beam to form nanoscale pores. The etched monolayer graphene is contacted with between 0.01 and 1 atmospheres of hydrogen, and held at a temperature of between room temperature and 500 K for a period of time to passivate the pore edges of the etched monolayer graphene with the hydrogen. In one embodiment, the etched, passivated monolayer graphene is then removed and applied to the etched microporous silica substrate. In another embodiment, the monolayer graphene is first placed on the the etched microporous silica substrate, and then the monolayer graphene is etched and passivated in place to form the etched, passivated monolayer graphene directly on the etched microporous silica substrate.

The etched, passivated monolayer graphene on the etched microporous silica substrate is placed in an evacuated chamber and heated to about 700° C. or greater for between 10 seconds to 30 minutes. The adhesion of the etched, passivated monolayer graphene to the etched microporous silica substrate may be released, and the etched, passivated monolayer graphene may adopt an equilibrated position on the microporous silica substrate. Subsequently, the etched, passivated monolayer graphene on the etched microporous silica substrate is cooled to less than 300° C. The etched, passivated monolayer graphene may adhere to the ridges of the etched microporous silica substrate. The portions of the etched, passivated monolayer graphene over the channels of the etched microporous silica substrate and between the ridges may then buckle or wrinkle according to the difference in thermal expansivity between monolayer graphene and the silica substrate, thus forming a wrinkled graphene filter including the wrinkled etched, passivated monolayer graphene on the the etched microporous silica substrate. The wrinkled etched, passivated monolayer graphene on the the etched microporous silica substrate may contract by a factor of about 10 in x and y dimensions such that the wrinkled surface has an effective nanoscale surface area of about 100 times greater than the nominal filter surface area.

### Example 2

A wrinkled graphene filter according to Example 1 is provided. A gas mixture is applied to one side of the wrinkled graphene filter with a pressure differential of between about 0.01 and 100 atmospheres at a temperature between room temperature and 300° C. The wrinkled graphene filter is provided at a pore size such that at least two component gases of the gas mixture have a permeance differential. For example, the wrinkled graphene filter may have pores corresponding to one or two carbon vacancies passivated with hydrogen. The gas mixture may include, for example, a small gas component such as hydrogen or helium, and a large gas component, such as methane or larger hydrocarbon gases. The small gas component is preferentially passed by the wrinkled graphene filter over the large gas component according to the permeance differential of the pores in the wrinkled gas. Because the wrinkled surface has an effective nanoscale surface area of about 100 times greater than the nominal filter surface area, the wrinkled graphene filter is about 100 times faster at separating the large and small gas components compared to a flat graphene filter of the same nominal filter surface area.

1. A method to make a graphene membrane, the method comprising:
providing a gas-permeable substrate comprising a convoluted surface;
applying graphene to the gas-permeable substrate;
heating the graphene applied to the gas-permeable substrate at a temperature suitable for the graphene to form a substantially flat surface over the gas-permeable substrate; and
cooling the graphene applied to the gas-permeable substrate to a temperature suitable for the graphene to form a wrinkled or buckled surface over the gas-permeable substrate.

2. The method of claim 1, further comprising forming nanopores in the graphene applied to the gas-permeable substrate.

3. The method of claim 2, wherein forming nanopores in the graphene applied to the gas-permeable substrate comprises reacting a compound represented by R-Het* with the graphene applied to the gas-permeable substrate, wherein:
Het* is nitrene or activated oxy;
R is —R^{a}, —SO₂R^{a}, —(CO)OR^{a}, or —SiR^{a}R^{b}R^{c}; and
R^{a}, R^{b}, and R^{c} are each independently aryl or heteroaryl.

4. The method of claim 1, wherein applying graphene to the gas-permeable substrate comprises applying nanopore-containing graphene to the gas-permeable substrate.

5. The method of claim 1, wherein providing the gas-permeable substrate comprises forming a convoluted structure comprising depressions or troughs and protuberances or ridges on the gas-permeable substrate.

6. The method of claim 5, wherein forming the convoluted surface on the gas-permeable substrate comprises one or more of nanoimprinting, photolithography, or etching.

7-14. (canceled)

15. The method of claim 1, wherein heating the graphene to obtain the substantially flat surface comprises heating the graphene applied to the gas-permeable substrate at a temperature of at least about 700° C.

16. The method of claim 1, wherein heating the graphene to obtain the substantially flat surface comprises heating the graphene applied to the gas-permeable substrate under a vacuum or an inert atmosphere.

17. The method of claim 1, wherein cooling the graphene to obtain the wrinkled or buckled surface comprises cooling the graphene applied to the gas-permeable substrate to a temperature less than about 300° C.

18. The method of claim 1, wherein cooling the graphene to obtain the wrinkled or buckled surface comprises cooling the graphene applied to the gas-permeable substrate under a vacuum or an inert atmosphere.

19. The method of claim 1, wherein applying graphene to the gas-permeable substrate comprises applying graphene to the gas-permeable substrate so that at least portion of the graphene contacts two or more protuberances or ridges formed on the gas-permeable substrate.

20. The method of claim 1, wherein applying graphene to the gas-permeable substrate comprises applying graphene to the gas-permeable substrate so that at least portion of the graphene is spaced apart from regions of the gas-permeable substrate disposed between protuberances or ridges formed on the gas-permeable substrate.

21. A graphene membrane comprising:
a gas-permeable substrate comprising a convoluted surface; and
a graphene layer on the gas-permeable substrate, the graphene layer including a wrinkled or buckled surface over the gas-permeable substrate, wherein the graphene layer includes one or more nanopores therein.

22. The graphene membrane of claim 21, wherein the graphene membrane is selectively permeable to H₂ relative to CH₄.

23-25. (canceled)

26. The graphene membrane of claim 21, wherein the gas-permeable substrate comprises silicon or silica.

27. The graphene membrane of claim 21, wherein the gas-permeable substrate has a pore volume of about 10% to about 30%.

28. The graphene membrane of claim 21, wherein the gas-permeable substrate has an average pore size of about 20 nm or more.

29. The graphene membrane of claim 21, wherein the gas-permeable substrate is permeable to hydrogen or helium.

30. (canceled)

31. The graphene membrane of claim 21, wherein the convoluted surface of the gas-permeable substrate comprises substantially parallel bands of protuberances or ridges.

32. A method to enrich a gas, the method comprising:
providing a graphene membrane comprising:
a gas-permeable substrate comprising a convoluted surface; and
a graphene layer on the gas-permeable substrate, the graphene layer including a wrinkled or buckled surface over the gas-permeable substrate, wherein the graphene layer comprises one or more nanopores; and
passing a first input gas through the graphene membrane to form an enriched gas.

33. The method of claim 32, wherein passing the first input gas comprises passing hydrogen or helium.

34. The method of claim 32, wherein passing the first input gas comprises passing hydrogen and methane.

35. The method of claim 32, wherein a concentration of hydrogen in the enriched gas is greater than a concentration of hydrogen in the first input gas.

36. The method of claim 32, wherein a concentration of helium in the enriched gas is greater than a concentration of helium in the first input gas.

37. The method of claim 32, wherein passing the first input gas through the graphene membrane comprises passing the first input gas through the graphene membrane at a pressure of at least about 1 atm.

38. The method of claim 32, wherein the enriched gas includes a first enriched gas, the method further comprising:
heating the graphene membrane at a temperature of at least about 700° C. after passing the first input gas through the graphene membrane;
cooling the graphene membrane to a temperature less than about 300° C.; and
passing a second input gas through the graphene membrane to form a second enriched gas.

39. The method of claim 38, wherein the second input gas has about a same composition as the first input gas.

40-46. (canceled)

47. The method of claim 1, wherein applying graphene to the gas-permeable substrate includes applying preformed graphene to the gas-permeable substrate, and wherein heating the graphene to form the substantially flat surface comprises heating the preformed graphene applied to the gas-permeable substrate at a temperature of at least about 700° C.

48. The graphene membrane of claim 21, wherein the gas-permeable substrate comprises protuberances or ridges patterned thereon.

49. The graphene membrane of claim 48, wherein the protuberances or ridges are spaced a distance of about 100 nm to about 1 mm.

50. The graphene membrane of claim 48, wherein the protuberances or ridges have a height of about 10 nm to about 1 mm.

51. The graphene membrane of claim 48, wherein the gas-permeable substrate includes substantially parallel bands and substantially parallel troughs disposed between the substantially parallel bands, wherein the substantially parallel bands are formed from the protuberances or ridges.
